(19) United States
(12) Patent Application Publication
(10) Pub. No.: US 2013/0299287 A1
(43) Pub. Date: Nov. 14, 2013

(54) VEHICLE DISC BRAKE ASSEMBLY HAVING A MECHANICALLY ACTUATED PARKING BRAKE

(71) Applicants: Manuel Barbosa, Novi, MI (US); Chad Brizendine, Fenton, MI (US); Mandeep Multani, Northville, MI (US)

(72) Inventors: Manuel Barbosa, Novi, MI (US); Chad Brizendine, Fenton, MI (US); Mandeep Multani, Northville, MI (US)

(73) Assignee: KELSEY-HAYES COMPANY, Livonia, MI (US)

(21) Appl. No.: 13/467,083

(22) Filed: May 9, 2012

(51) Int. Cl. B60T 1/06; F16D 65/18; F16D 65/52

(52) U.S. Cl. 188/71.9

(57) ABSTRACT

A vehicle disc brake assembly having a mechanical parking brake comprises: a piston carried by the brake assembly, the piston having a bore provided with an inner cone surface and an internal groove formed in an inner wall of the bore; an adjusting strut part disposed within the piston bore, the strut part having a flange configured to contact the inner cone surface; and a single, one-piece clutch spring carried by the strut part within the piston bore; wherein the clutch spring includes a main body having a plurality of legs extending therefrom, each of the legs including an outermost remote end configured to be received in the groove of the piston to secure the clutch spring within the piston and each of the legs configured to provide a spring force operative to bias the flange of the strut part against the inner cone surface of the piston.

### BACKGROUND OF THE INVENTION

This invention relates in general to vehicle disc brake assemblies and in particular to an improved structure for a vehicle disc brake assembly having a mechanically actuated parking brake.

Most vehicles are equipped with a brake system for slowing or stopping movement of the vehicle in a controlled manner. A typical brake system for a vehicle can include a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

Use of rear wheel disc brakes requires an adequate and dependable mechanical parking brake system which is typically integral to the disc brake. Such an integral mechanical parking brake system preferably includes an adjustment mechanism whereby the friction pad to rotor clearance is maintained and automatically adjusted for friction pad wear. Such rear wheel disc brakes having a mechanical parking brake system which is integral to the disc brake are disclosed in U.S. Pat. No. 5,060,765 to Meyer, U.S. Pat. No. 5,038,895 to Evans and U.S. Pat. No. 6,478,120 B2 to Runkel et al.

### SUMMARY OF THE INVENTION

This invention relates to an improved structure for a vehicle disc brake assembly having a mechanically actuated parking brake.

According to one embodiment, the vehicle disc brake assembly having the mechanical parking brake comprises: a piston carried by the vehicle disc brake assembly, the piston having a bore provided with an inner cone surface and an internal groove formed in an inner wall of the bore; an adjusting strut part disposed within the bore of the piston, the strut part having a flange provided thereon and configured to contact the inner cone surface; and a single, one-piece clutch spring carried by the strut part within the bore of the piston; wherein the clutch spring includes a main body having a plurality of legs extending therefrom, each of the legs including an outermost remote end configured to be received in the internal groove of the piston to thereby secure the clutch spring within the piston and each of the legs configured to provide a spring force which is operative to bias the flange of the strut part against the inner cone surface of the piston.

According to another embodiment, the clutch spring has a generally annular shape and the main body is generally annular and flat and includes a central opening provided therein.

According to another embodiment, each of the legs is bifurcated and includes a first leg portion, a second leg portion, a third leg portion, a fourth leg portion, and a fifth leg portion. According to this embodiment, the first leg portion is a generally curved transition leg portion and extend generally perpendicular to the main body, the second leg portion extends in a generally axially outwardly extending direction relative to the main body, the third leg portion is angled inwardly so as to extend in a generally radially inwardly extending direction relative to the second leg portion, the fourth leg portion is angled slightly inwardly so as to extend in a generally radially inwardly extending direction relative to the third leg portion, and fifth leg portion is curved in a radially outwardly extending direction relative to the fourth leg portion.

According to another embodiment, each of the legs further includes a protuberance provided thereon which extends in a direction back toward the and past the main body.

According to another embodiment, each of the legs is axially deflectable relative to the main body.

According to another embodiment, each of the legs is radially deflectable relative to the main body.

According to another embodiment, each of the legs is axially and radially deflectable relative to the main body.

According to another embodiment, the clutch spring is one of an at least three leg spiral clutch spring, an at least three leg double-loop single finger clutch spring, an at least three leg fork-loop clutch spring, and an at least three leg single-loop clutch spring.

According to another embodiment, the vehicle disc brake assembly having a mechanical parking brake comprises: a piston carried by the vehicle disc brake assembly, the piston having a bore provided with an inner cone surface and an internal groove formed in an inner wall of the bore; an adjusting strut part disposed within the bore of the piston, the strut part having a flange provided thereon and configured to contact the inner cone surface; and a single, one-piece clutch spring carried by the strut part within the bore of the piston; wherein the clutch spring is generally annular in shape and includes a main body having a plurality of legs extending therefrom, the main body having a central opening provided therein, each of the legs including an outermost remote end configured to be received in the internal groove of the piston to thereby secure the clutch spring within the piston and each of the legs configured to provide a spring force which is operative to bias the flange of the strut part against the inner cone surface of the piston, and each of the legs being deflectable relative to the main body.

According to another embodiment, the vehicle disc brake assembly having a mechanical parking brake comprises: a piston carried by the vehicle disc brake assembly, the piston having a bore provided with an inner cone surface and an internal groove formed in an inner wall of the bore; an adjusting strut part disposed within the bore of the piston, the strut part having a flange provided thereon and configured to contact the inner cone surface; and a single, one-piece clutch spring carried by the strut part within the bore of the piston; wherein the clutch spring includes a main body having at least three legs extending therefrom, each of the legs including an outermost remote end configured to be received in the internal groove of the piston to thereby secure the clutch spring within the piston and each of the legs configured to provide a spring force which is operative to bias the flange of the strut part against the inner surface of the piston, and wherein each of the legs is axially and radially deflectable relative to the main body.

Other advantages of this invention will become apparent to those skilled in the art from the following detailed description of the invention, when read in light of the accompanying drawings.

### BRIEF DESCRIPTION OF THE DRAWINGS

FIG. 1 is a sectional view of a portion of a prior art vehicle disc brake assembly.

FIG. 2 is a sectional view of selected components of a prior art vehicle disc brake assembly.

FIG. 3 is an exploded perspective view of selected components of the vehicle disc brake assembly illustrated in prior art FIGS. 1 and 2.

FIG. 4 is a sectional view of selected components of a first embodiment of a vehicle disc brake assembly constructed in accordance with the present invention.

FIG. 5 is an exploded perspective view of selected components of the vehicle disc brake assembly illustrated in FIG. 4.

FIGS. 6 and 7 are perspective views of a clutch spring of the vehicle disc brake assembly illustrated in FIGS. 4-5.

FIGS. 8A and 8B are selected views of the clutch spring showing the installed state thereof.

FIGS. 9A and 9B are selected views of the clutch spring showing the free or uninstalled state thereof.

FIGS. 10-18 are views showing other embodiments of a spring clutch in accordance with the present invention.

### DETAILED DESCRIPTION OF THE PREFERRED EMBODIMENTS

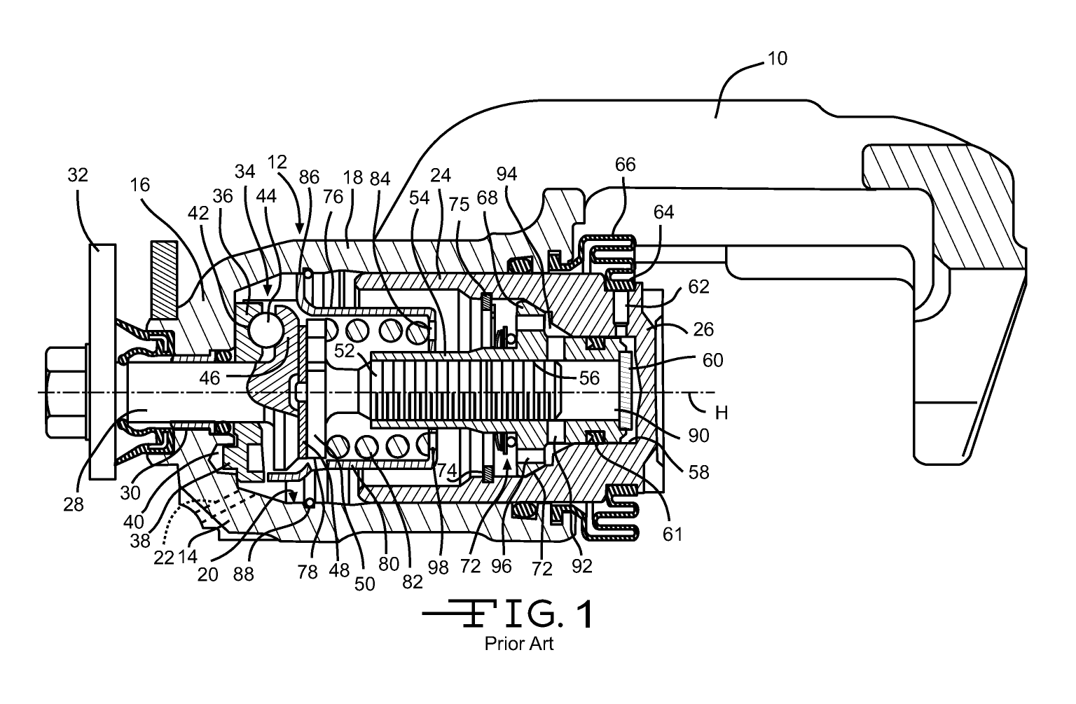

Referring now to the drawings, there is illustrated in prior art FIG. 1 a portion of a prior art vehicle disc brake assembly having an integral mechanical parking brake system, taken from U.S. Pat. No. 6,478,120 B2 to Runkel et al., the disclosure of this patent incorporated herein by reference in entirety. The general structure and operation of the prior art vehicle disc brake assembly is conventional in the art and thus, only those portions of the prior art vehicle disc brake assembly which are necessary for a full understanding of this invention will be explained and illustrated. Although the invention will be described and illustrated in connection with the particular kind of prior art vehicle disc brake assembly disclosed herein, it will be appreciated that the invention may be used in connection with other kinds of vehicle disc brake assembly structures if so desired, such as for example, as shown in U.S. Pat. No. 5,060,765 to Meyer and/or U.S. Pat. No. 5,038,895 to Evans, the disclosures of these patents incorporated herein by reference in their entirety.

As shown in FIG. 1, the illustrated prior art vehicle disk brake assembly has a “floating” or “sliding” brake caliper 10, which is guided on a brake carrier (not shown) so as to be in a conventional manner displaceable parallel to the axis of a brake disk or rotor (not shown). Accommodated in the brake caliper 10 is a combined mechanical parking brake actuating apparatus and friction pad wear adjuster mechanism, indicated generally at 12, by means of which the friction linings (not shown), also known as brake linings, may be pressed against the brake rotor.

The actuating apparatus 12 comprises a housing 14, which in the illustrated embodiment is formed integrally with the brake caliper 10 and which comprises a housing base 16 and a housing shell 18. Formed in the housing 14 is a cylinder bore 20, which is open towards the non-illustrated brake rotor and may be supplied with brake fluid through an inlet channel 22, which is illustrated by dashed lines in prior art FIG. 1. Displaceably guided in the cylinder bore 20 is a cup-shaped piston 24, the closed end wall 26 of which is intended for application against one of the brake linings.

In the housing base 16, a shaft 28 is supported isoaxially with the piston 24 in a rotatable and axially displaceable manner in a bearing bush 30. The actuating apparatus 12 is mechanically actuable by means of the shaft 28. For this purpose, a lever 32 is fastened to the outer end of the shaft 28 and connected, for example, by means of a Bowden cable to a parking brake lever or a parking brake pedal (not shown).

Lying against the inside of the housing base 16 is an expanding device, here in the form of a ball ramp arrangement 34, comprising an annular-disk-shaped “housing-fixed” plate 36 which is slipped onto and centered on the shaft 28. The plate 36 is locked against rotation on the housing 14 by means of a pin 38, which engages into an axially parallel blind hole 40 in the housing base 16.

Formed on the housing-fixed plate 36 are three, in the peripheral direction, elongate, trough-like ramps 42, each of which receives an, in the illustrated embodiment, a spherical expanding body 44. The expanding bodies 44 each cooperate with a corresponding ramp of a further, likewise annular-disk-shaped plate 46, which is axially adjustable and which in the illustrated embodiment is formed integrally with the shaft 28. The axially adjustable plate 46 is supported in the axial direction, counter to a pressure exerted by the expanding bodies 44, via a thrust bearing 48 against an abutment 50 forming part of an adjusting strut of the adjuster mechanism 12 which is variable in length.

The adjusting strut comprises a first, bolt-shaped strut part 52, which in the illustrated embodiment is formed integrally with the abutment 50, and a second, substantially sleeve-shaped or nut-shaped strut part 54, into which the first strut part 52 is screwed. For this purpose, a non-self locking steep-lead-angle thread pairing 56 is situated between the two strut parts 52 and 54. As will be explained later, the effective length of the adjusting strut, which is formed by the two strut parts 52 and 54 and disposed isoaxially relative to the piston 24 and the shaft 28, increases in accordance with the gradually advancing lining wear of the brake linings. The sleeve-shaped strut part 54 in its, in prior art FIG. 1, right end portion is designed as an auxiliary piston and is guided displaceably in a corresponding auxiliary cylinder bore 58 of the piston 24.

The end of the sleeve-shaped strut part 54 facing the end wall 26 of the piston 24 is tightly sealed by means of a base plate 60 and a seal 61. The part of the auxiliary cylinder bore 58 delimited by the base plate 60 and the end wall 26, so that it remains constantly unpressurized, is connected by a radial vent channel 62 to an external groove 64 of the piston 24. Accommodated in the groove 64 is one end of bellows 66, which connects the end of the piston 24 projecting from the cylinder bore 20 to the housing 14 and so protects the cylinder bore 20 from fouling.

Formed on the sleeve-shaped strut part 54 is a conical flange 68, with which an inner cone surface 70 of the piston 24 is associated. Inside the piston 24 a spring washer arrangement, indicated generally at 72, is arranged with axial bias between the flange 68 and a retaining ring 74, which is snapped into an annular groove 75 provided in an inner wall of the piston 24. The spring washer arrangement 72 normally holds the flange 68 applied against the inner cone surface 70 and thereby prevents a rotation of the sleeve-shaped strut part 54 relative to the piston 24. The piston 24 is in turn prevented from rotating by conventional means, for example by virtue of its cooperating with the non-illustrated brake lining.

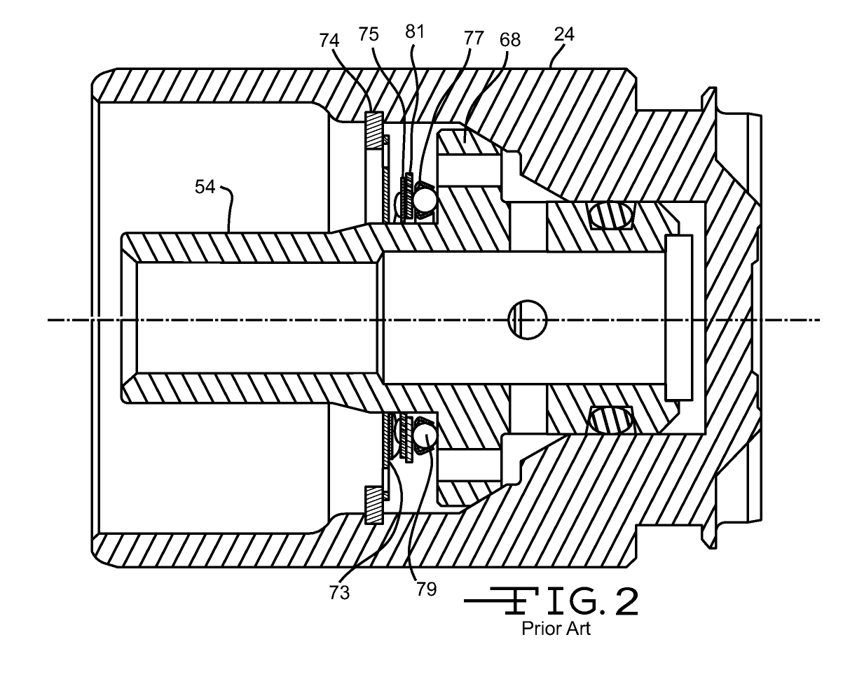

As best shown in one or more of prior art FIGS. 2-3, in this embodiment, the spring washer arrangement 72 includes a “scalloped flat” washer 73, a “wavy” washer or spring 75, and “flat” washer 81. Further, in this embodiment a bearing cage 77 containing bearings 79 is also provided within the piston 24 and on the strut part 54. As can be seen, the bearing cage 77 is disposed between the flange 68 and the washer 81 and the wavy washer 75 is disposed between the washer 81 and the washer 73.

Disposed inside the cylinder bore 20—and extensively inside the cup-shaped piston 24—is an approximately pot-shaped spring cage 76, which is locked against axial displacement and against rotation on the housing 14. The spring cage 76 is fashioned in such a way that it locks the bolt-shaped strut part 52 against rotation without impeding an axial displacement of the latter. To this end, a radial projection 78 of the abutment 50 engages into a longitudinal groove 80 of the spring cage 76.

In the illustrated embodiment a helically formed restoring spring 82 is supported by its one end against the side of the abutment 50 remote from the thrust bearing 48, while its other end is supported in the spring cage 76 against the base 84 of the latter. The restoring spring 82 is clamped in between the base 84 of the spring cage 76 and the abutment 50 and presses the ball ramp arrangement 34 into its normal position, in which the two plates 36 and 46 are the minimum axial distance apart from one another.

The spring cage 76 has a radially outward projecting bottom edge 86, which engages behind a radially resilient fastening element 88 snapped into the cylinder bore 20. The spring cage 76 accordingly presses via the restoring spring 82, the abutment 50, the thrust bearing 48 and the adjustable plate 46 as well as the expanding body 44 against the plate 36, thereby preventing the latter from being displaced axially away from the housing base 16.

There now follows a functional description of the actuating apparatus 12. Upon a hydraulic brake actuation at a moderate pressure which does not significantly deform the floating caliper 10 and the friction material of the brake linings, the piston 24 is displaced in the direction of the non-illustrated brake disk, i.e. out of the cylinder bore 20. So long as the displacement is not greater than the thread clearance, which exists in the steep-lead-angle thread pairing 56 between the strut parts 52 and 54 and corresponds to the intended brake clearance, the sleeve-shaped strut part 54 participates fully in the displacement of the piston 24 and the spring washer arrangement 72 does not yet give.

When, however, as a result of wear of the brake linings the piston 24 has to travel a distance exceeding the intended brake clearance in order to apply the brake linings against the brake disk, the bolt-shaped strut part 52, which is held fast by restoring spring 82, prevents the sleeve-shaped strut part 54 during hydraulic actuation from participating in the entire displacement of the piston 24 towards the brake disk. Consequently, the conical flange 68 of the sleeve-shaped strut part 54 is lifted slightly off the inner cone surface 70 of the piston 24 counter to the resistance of the spring washer arrangement 72, which is weaker than the bias of the restoring spring 82. The sleeve-shaped strut part 54 is then no longer prevented from rotating about its axis.

The axial force, which is transmitted by the steep-lead-angle thread pairing 56 and with which the bolt-shaped strut part 52 attempts to restrain the sleeve-shaped strut part 54, has a peripheral component and therefore generates a torque, by means of which the sleeve-shaped strut part 54 is then rotated in such a way that it unscrews slightly from the bolt-shaped strut part 52. The conical flange 68 therefore comes to lie once more against the inner cone surface 70 of the piston 24. Because the effective length of the adjusting strut formed by the two strut parts 52 and 54 is then increased, the piston 24 after the brake actuation is no longer able to return into its original starting position, with the result that the brake clearance has been reduced back down to its setpoint value.

When the brake is to be actuated mechanically, for example such as during a parking brake operation, the shaft 28 is then rotated by means of the lever 32. The spherical expanding bodies 44 subsequently run up the ramps 42 of the two plates 36 and 46 and press the adjustable plate 46 axially in the direction of the non-illustrated brake disk. In this case, the plate 46 via the thrust bearing 48 exerts upon the abutment 50 and hence upon the bolt-shaped strut part 52 an axial pressing force which is transmitted from the steep-lead-angle thread pairing 56, after the thread clearance is overcome, to the sleeve-shaped strut part 54 and from the latter via the conical flange 68 and the inner cone surface 70 to the piston 24. The sleeve-shaped strut part 54 is in said case prevented from rotating so that the two strut parts 52 and 54 during a mechanical actuation form a completely rigid strut.

To enable the actuating apparatus 12 to be actuated hydraulically, its interior first has to be filled with brake fluid. This occurs through the already mentioned inlet channel 22. It is important that the filling with brake fluid is effected as completely as possible because air-filled cavities left behind in the actuating apparatus 12 lead at a later stage of operation to a perceptible lengthening of the actuating travel during a hydraulic actuation because said “air bubbles” first have to be compressed before it is possible to increase the pressure in the actuating apparatus up to the amount required for braking.

To enable the brake fluid to fill the interior of the actuating apparatus 12 as completely as possible and, in particular, pass into a cavity 90 formed in the sleeve-shaped strut part 54 between the end of the bolt-shaped strut part 52 and the base plate 60, the sleeve-shaped strut part 54 is provided in the region of the cavity 90 with a plurality of radial bores 92, which connect the cavity 90 to the outer peripheral surface of the sleeve-shaped strut part 54. The radial bores 92 open outside of the sleeve-shaped strut part 54 into an annular channel 94 which, as illustrated, is delimited by the strut part 54, its conical flange 68 and the inside of the piston 24.

For connection of the annular channel 94 to the cylinder bore 20, a plurality of axial through-bores 96 are disposed in the conical flange 68. To enable all of the air contained in the cavity 90 to be fully displaced by the brake fluid flowing in, the radial bores 92 and the axial through-bores 96 are disposed relative to one another in such a way that, in any rotational position of the sleeve-shaped strut part 54 relative to the housing shell 18 and/or piston 24, at least one radial bore 92 and one axial through-bore 96 are situated above a horizontal reference plane H extending through the longitudinal centre line of the adjusting strut. Furthermore, the two bores 92 and 96 are disposed in such a way that the radially outer end of the bore 92 lies, in relation to the reference plane H, below at least one part of the axial through-bore 96. This means that in any rotational position of the sleeve-shaped strut part 54 at least one part of an axial through-bore 96 is, in relation to the reference plane H, higher than the radially outer end of the, in relation to the reference plane H, highest radial bore 92.

To improve the flow conditions inside the actuating apparatus 12 further, the retaining ring 74 has a round cross section. Furthermore, to keep the flow resistance inside the actuating apparatus 12 low, a plurality of through-openings 98 are provided in the base 84 of the spring cage 76. The structure and operation of the disc brake assembly thus far described is conventional in the art.

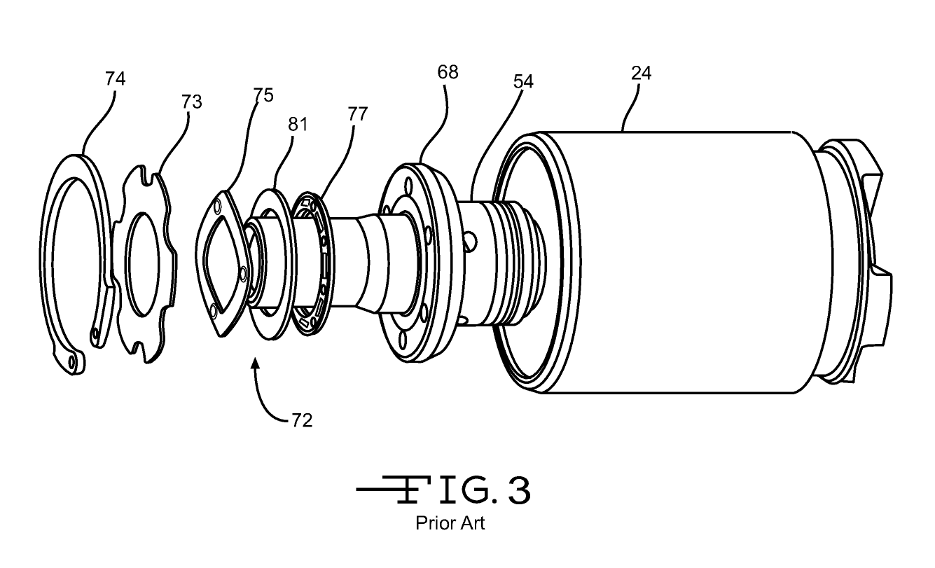

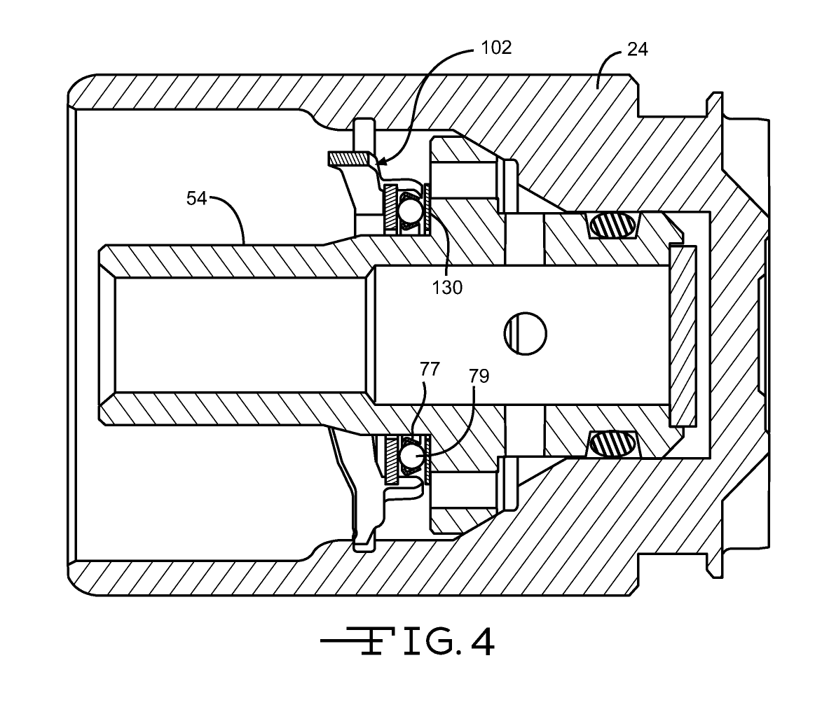

Referring now to one or more of FIGS. 4-5 and using like reference numbers to indicate corresponding parts, there is illustrated a portion of a vehicle disc brake assembly, indicated generally at 100, constructed in accordance with a first embodiment of the present invention. As shown therein, in this embodiment, there is provided a single, one-piece “spiral clutch” spring or member, indicated generally at 102, best shown in FIGS. 6-9B. The clutch spring 102 is formed from a suitable material, such as for example stainless steel having an approximate thickness of 0.90 mm, or spring steel or other suitable metal and/or non-metal materials if so desired.

As best shown in FIGS. 6-9B, the clutch spring 102 is generally annular in shape and includes a first central or inner part or main body 104, and plurality of second “outer” parts or legs 106 which extend from the main body 104. The main body 104 is generally annular and flat in shape, extends in a plane P1 which is generally perpendicular to a central axis X of the clutch spring 102 and further includes a central opening 108 provided therein. The main body 104 includes an outer circumferential edge 110 which defines an outer diameter D1 of the main body 104. The main body 104 includes an outer surface 104A and the main body 104 is effective to define a generally flat washer portion of the spring washer 102.

In the illustrated embodiment, the clutch spring 102 is preferably provided with three uniquely shaped or configured “deflectable” legs 106 which are identical to one another. Each leg 106 is bifurcated or undulated and includes a first leg portion 112, a second leg portion 114, a third leg portion 116, a fourth leg portion 118, and a fifth leg portion 120. The first leg portion 112 is a generally “curved transition” leg portion and extend generally perpendicular to the main body 104 so as to be effective to connect the remaining leg portions, i.e., leg portions 114-120, of the leg 106 to the main body 104 of the clutch spring 102.

In the illustrated embodiment, the second leg portion 114 is a generally flat planar leg portion having a generally flat planar outer surface 114A. The second leg portion 114 extends in a generally axially outwardly extending direction or perpendicular relative to the main body 104 of the clutch spring 102. The outer surface 114A of the second leg portion 114 is located a first radial distance R1 relative to the axis X of the clutch spring 102.

In the illustrated embodiment, the third leg portion 116 is a generally flat planar leg portion having a generally flat planar outer surface 116A. The third leg portion 114 is angled slightly inwardly so as to extend in a generally radially inwardly extending direction relative to the second leg portion 114 of the leg 106 of the clutch spring 102. In the illustrated embodiment, the third leg portion 116 is angled at a first angle A1 relative to the second leg portion 114 of the leg 106 of the spring clutch 102 when the clutch spring 102 is in the uninstalled state as shown in FIG. 10A. In the illustrated embodiment, the first angle A1 is preferably approximately 148 degrees.

In the illustrated embodiment, the fourth leg portion 118 is a generally flat planar leg portion having a generally flat planar outer surface 118A. The fourth leg portion 114 is angled slightly inwardly so as to extend in a generally radially inwardly extending direction relative to the third leg portion 116 of the leg 106 of the clutch spring 102. In the illustrated embodiment, the fourth leg portion 118 is angled at a second angle A1 relative to third leg portion 114 of the leg 106 of the spring clutch 102 when the clutch spring 102 is in the uninstalled state as shown in FIG. 10A. In the illustrated embodiment, the second angle A2 is preferably approximately 157 degrees.

In the illustrated embodiment, the fifth leg portion 120 is a generally curved leg portion having a remote end or member 120A. The fifth leg portion 114 is curved in a radially outwardly extending direction relative to the fourth leg portion 118 of the leg 106 of the clutch spring 102. In the illustrated embodiment, the fifth leg portion 120 is angled at a third angle A3 relative to fourth leg portion 118 of the leg 106 of the spring clutch 102 when the clutch spring 102 is in the uninstalled state as shown in FIG. 10A. In the illustrated embodiment, the third angle A3 is preferably approximately 108 degrees.

Also, in the illustrated embodiment, the remote end 120A of the fifth leg portion 120 includes a uniquely profiled or shaped “retaining” tab 122. The tab 122 includes an outermost end surface 122A which defines an outer diameter D2 of the leg 106 of the clutch spring 102 when the clutch spring 102 is in the free or uninstalled state, as best shown in FIGS. 9A-9B. The outer diameter D2 is the largest diameter of each of the legs 106 of the clutch spring 102.

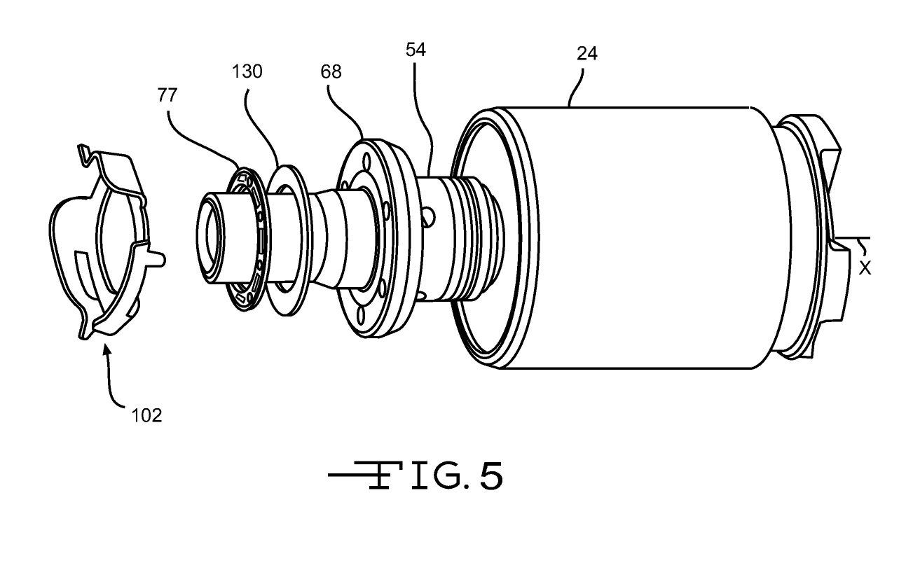

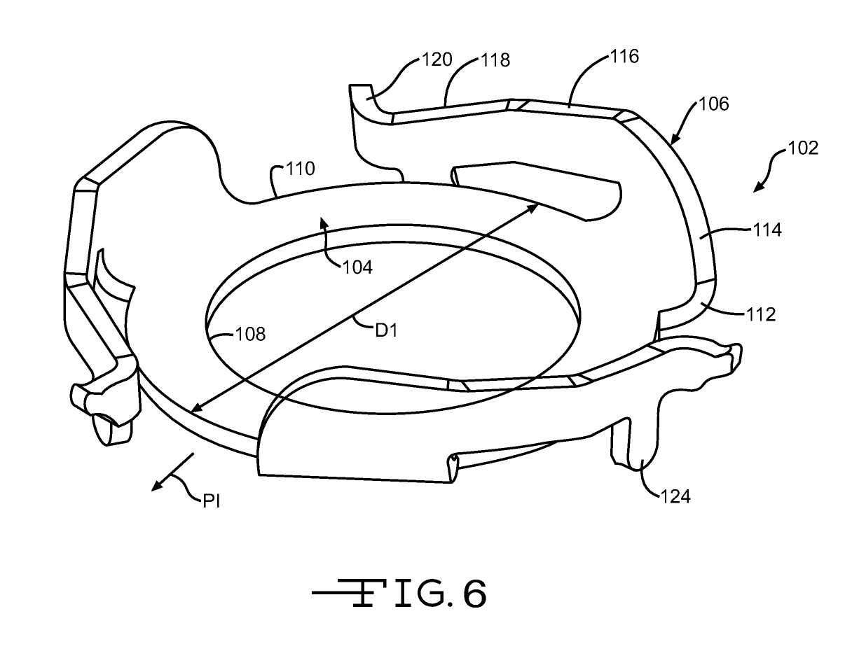

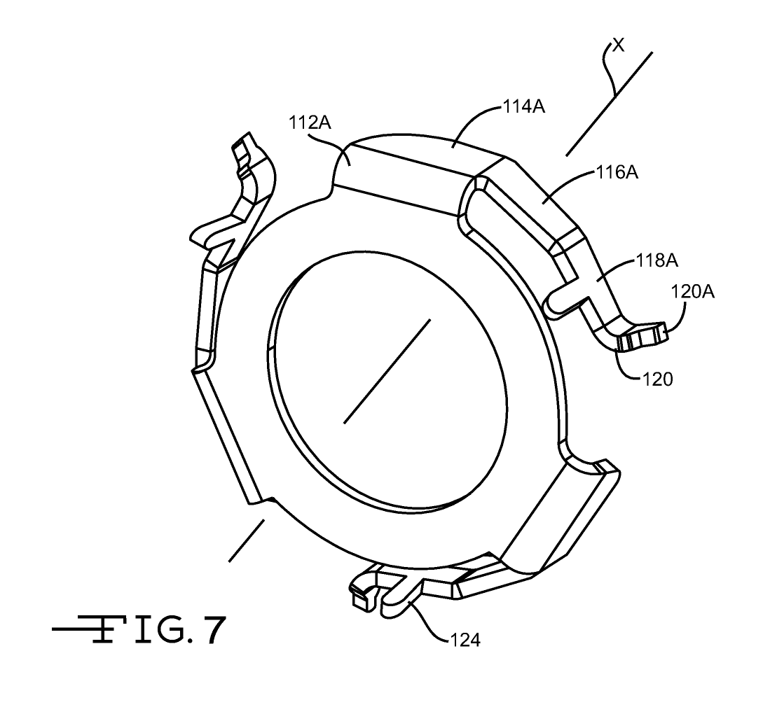

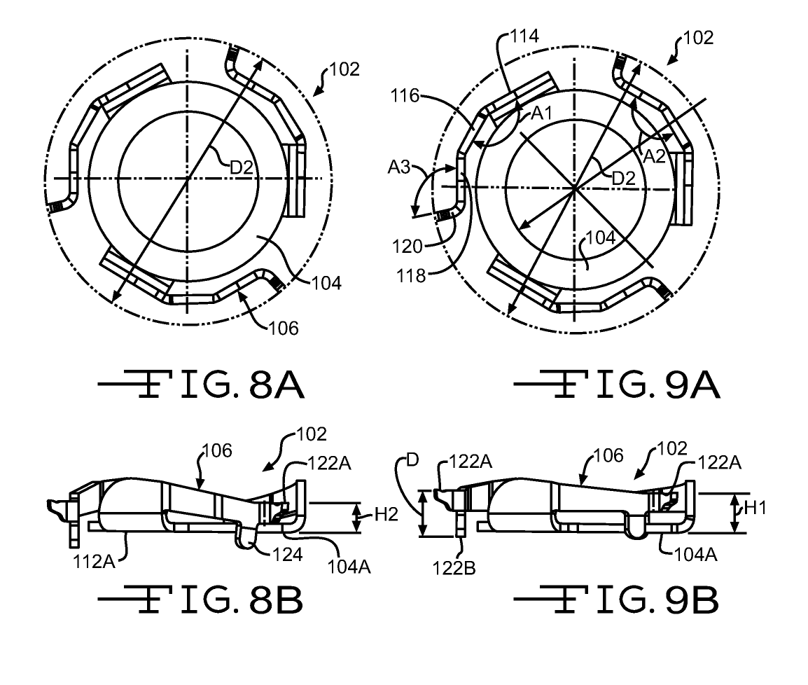

As best shown in FIG. 4, in use when the clutch spring 102 is installed, the legs 106 are operative to be initially deflected radially inwardly and then spring back radially outwardly, so that the tab 122 can be operatively disposed in the groove 75 provided in the inner wall of the piston 24 to thereby locate and install the clutch spring 102 within the piston 24. As can be seen in FIGS. 8A and 8B, which shows the clutch spring 102 in its installed state but not mounted within the piston 24, once installed the clutch spring 102 defines an outer diameter D3 which is slightly less than the outer diameter D2 of the uninstalled clutch spring 102. As can be understood, once the clutch spring 102 is installed within the piston 24 the clutch spring 102 is effective to react against, i.e., to apply an axial biasing or spring force to, the balls 79 in the ball cage 77.

Also, as can be seen in comparing FIGS. 8B and 9B, when the clutch spring 102 is in the uninstalled state as shown in FIG. 9B, an inner end 122A of the tab 122 extends a first axial distance H1 relative to the outer surface 104A of the main body 104. In the installed state as shown in FIG. 8B, the inner end 122A of the tab 122 extends a second axial distance H2 which is less than the first axial distance H1. As a result of this, when the clutch spring 102 is in the installed state the clutch spring 102 is “spring-loaded” in the axial direction and thereby applies a spring force which is operative, via the balls 79, to bias the flange 68 of the strut part 54 against the inner cone surface 70 of the piston 24.

In the illustrated embodiment, each leg 106 further includes an optional lobe or protuberance 124 provided thereon. In the illustrated embodiment, the lobe 124 is a generally axially extending lobe which extends in a generally axial direction a predetermined distance D between opposed end surfaces 122A and 122B thereof when the clutch spring 102 is in the uninstalled state, as best shown in FIG. 9B. As a result of this, when the clutch spring 102 is in the installed state as best shown in FIG. 8B, the end 122B of the lobe 124 extends past or beyond the outer surface 104A of the main body 104 of the clutch spring 102 and the outer surface 112A of the first leg portion 112.

Also, in the illustrated embodiment, if the lobe 124 is provided it is also preferably provided on the fourth leg 118 so as to be generally near the tab 122. In use, the lobes 124 are operative to function as a stop so as to engage the strut 54 in certain instances, such as for example if the strut 54 travels beyond a predetermined “axial” distance, to thereby prevent the strut 54 from directly engaging the leg 114 which could cause the tab 122 from being moved out of engagement in the groove 75 of the piston 24. Alternatively, the shape, construction, number, configuration, orientation, profile, and/or design of the clutch spring 102, including the main body 104 and/or one or more of the legs 106, can be other than illustrated and described if so desired.

Also, in the illustrated embodiment, the vehicle disc brake assembly 100 further includes an optional washer 130 disposed on the strut 54. The washer 130 is provided between the bearing cage 77 and the flange 68 of the strut 54. The washer 130 may be needed in certain applications where the spring force which is provided by the clutch spring 102 is such that is can cause the balls 79 in the bearing cage 77 to form or “roll” a groove into the adjacent surface of the flange 68 of the strut 54 if the washer 130 was not present. However, if the spring force provided by the clutch spring 102 is not of a force which would cause grooving of such surface by the balls 79, then the washer 130 would not be needed and thus is optional, if so desired. Also, if at least the surface of the flange 68 of the strut 54, which the balls 79 would contact via the spring force provided by the clutch spring 102, was hardened to prevent grooving of such surface by the balls 79, then the washer 130 would also not be needed and thus optional, if so desired.

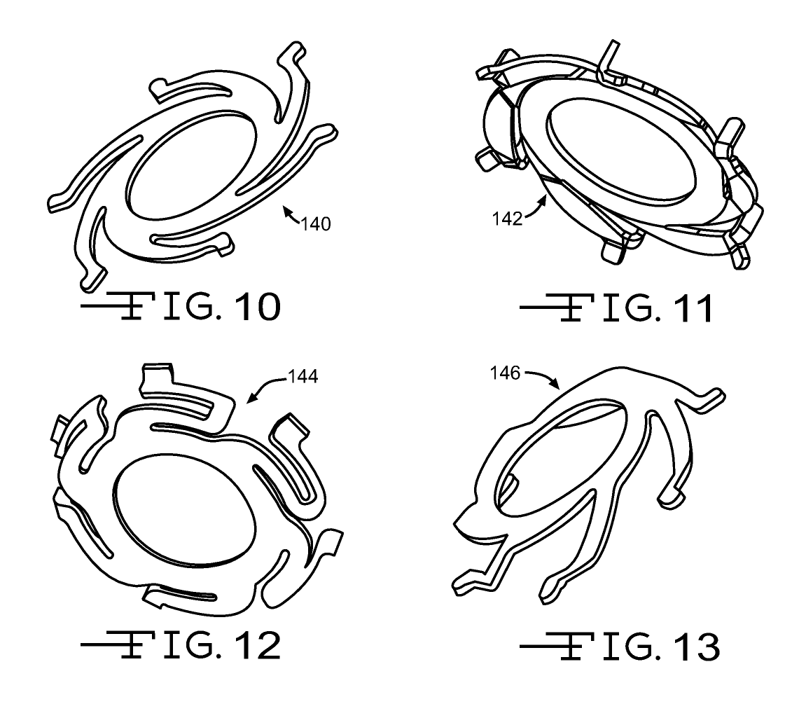

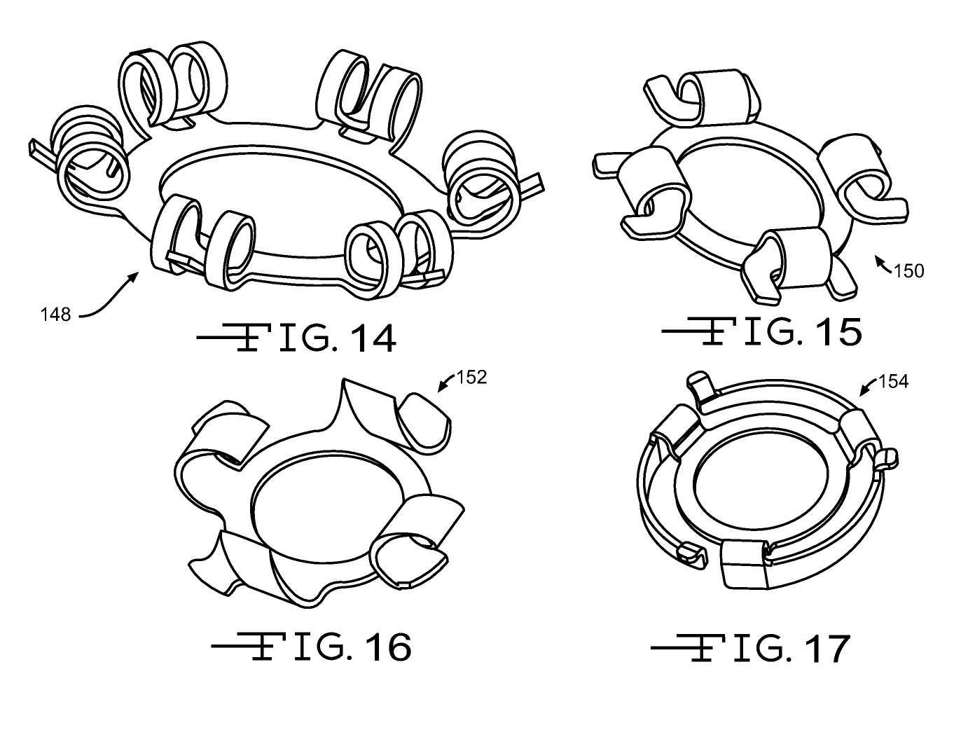

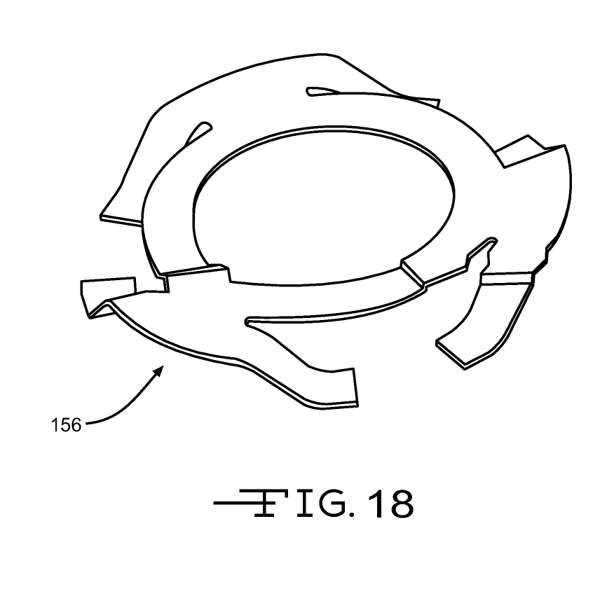

Referring now to FIGS. 10-18, there are views showing other embodiments of a spring clutch in accordance with the present invention. As shown in FIGS. 10-13, in each of these embodiments there is illustrated a six leg “spiral” clutch spring at 140, 142, 144 and 146, respectively. As shown in FIG. 14, in this embodiment there is illustrated a six leg “double-loop single finger” clutch spring at 148. As shown in FIG. 15, in this embodiment there is illustrated a four leg “fork-loop” clutch spring at 150. As shown in FIG. 16, in this embodiment there is illustrated a four leg “single-loop” clutch spring at 152. As shown in FIG. 17, in this embodiment there is illustrated a three-leg “spiral” clutch spring at 154.

Referring now to FIG. 18, there is illustrated another embodiment of a clutch spring in accordance with the present invention. As shown therein, in this embodiment there is illustrated a three leg “double-fingered” clutch spring at 156. Also, in this embodiment, the clutch spring 156 does not include an outer tab for installing the clutch spring 156 in the groove 75 of the piston 24. As a result of this, the retaining ring 74 shown in prior art FIG. 1 would need to be used in connection with the use of the clutch spring 156.

In accordance with the provisions of the patent statues, the principle and mode of operation of this invention have been described and illustrated in its preferred embodiments. However, it must be understood that the invention may be practiced otherwise than as specifically explained and illustrated without departing from the scope or spirit of the attached claims.

What is claimed is:

1. A vehicle disc brake assembly having a mechanical parking brake comprising:
a piston carried by the vehicle disc brake assembly, the piston having a bore provided with an inner cone surface and an internal groove formed in an inner wall of the bore;
an adjusting strut part disposed within the bore of the piston, the strut part having a flange provided thereon and configured to contact the inner cone surface; and
a single, one-piece clutch spring carried by the strut part within the bore of the piston;
wherein the clutch spring includes a main body having a plurality of legs extending therefrom, each of the legs including an outermost remote end configured to be received in the internal groove of the piston to thereby secure the clutch spring within the piston and each of the legs configured to provide a spring force which is operative to bias the flange of the strut part against the inner cone surface of the piston.

2. The vehicle disc brake assembly of claim 1 wherein the clutch spring has a generally annular shape and the main body is generally annular and flat and includes a central opening provided therein.

3. The vehicle disc brake assembly of claim 1 wherein each of the legs is bifurcated and includes a first leg portion, a second leg portion, a third leg portion, a fourth leg portion, and a fifth leg portion.

4. The vehicle disc brake assembly of claim 3 wherein the first leg portion is a generally curved transition leg portion and extend generally perpendicular to the main body, the second leg portion extends in a generally axially outwardly extending direction relative to the main body, the third leg portion is angled inwardly so as to extend in a generally radially inwardly extending direction relative to the second leg portion, the fourth leg portion is angled slightly inwardly so as to extend in a generally radially inwardly extending direction relative to the third leg portion, and fifth leg portion is curved in a radially outwardly extending direction relative to the fourth leg portion.

5. The vehicle disc brake assembly of claim 1 wherein each of the legs further includes a protuberance provided thereon which extends in a direction back toward the and past the main body.

6. The vehicle disc brake assembly of claim 1 wherein each of the legs is axially deflectable relative to the main body.

7. The vehicle disc brake assembly of claim 1 wherein each of the legs is radially deflectable relative to the main body.

8. The vehicle disc brake assembly of claim 1 wherein each of the legs is axially and radially deflectable relative to the main body.

9. The vehicle disc brake assembly of claim 1 wherein the clutch spring is one of an at least three leg spiral clutch spring, an at least three leg double-loop single finger clutch spring, an at least three leg fork-loop clutch spring, and an at least three leg single-loop clutch spring.

10. A vehicle disc brake assembly having a mechanical parking brake comprising:
a piston carried by the vehicle disc brake assembly, the piston having a bore provided with an inner cone surface and an internal groove formed in an inner wall of the bore;
an adjusting strut part disposed within the bore of the piston, the strut part having a flange provided thereon and configured to contact the inner cone surface; and
a single, one-piece clutch spring carried by the strut part within the bore of the piston;
wherein the clutch spring is generally annular in shape and includes a main body having a plurality of legs extending therefrom, the main body having a central opening provided therein, each of the legs including an outermost remote end configured to be received in the internal groove of the piston to thereby secure the clutch spring within the piston and each of the legs configured to provide a spring force which is operative to bias the flange of the strut part against the inner cone surface of the piston, and each of the legs being deflectable relative to the main body.

11. The vehicle disc brake assembly of claim 10 wherein each of the legs is bifurcated and includes a first leg portion, a second leg portion, a third leg portion, a fourth leg portion, and a fifth leg portion.

12. The vehicle disc brake assembly of claim 11 wherein the first leg portion is a generally curved transition leg portion and extend generally perpendicular to the main body, the second leg portion extends in a generally axially outwardly extending direction relative to the main body, the third leg portion is angled inwardly so as to extend in a generally radially inwardly extending direction relative to the second leg portion, the fourth leg portion is angled slightly inwardly so as to extend in a generally radially inwardly extending direction relative to the third leg portion, and fifth leg portion is curved in a radially outwardly extending direction relative to the fourth leg portion.

13. The vehicle disc brake assembly of claim 10 wherein each of the legs further includes a protuberance provided thereon which extends in a direction back toward the and past the main body.

14. The vehicle disc brake assembly of claim 10 wherein each of the legs is axially deflectable relative to the main body.

15. The vehicle disc brake assembly of claim 10 wherein each of the legs is radially deflectable relative to the main body.

16. The vehicle disc brake assembly of claim 10 wherein each of the legs is axially and radially deflectable relative to the main body.

17. A vehicle disc brake assembly having a mechanical parking brake comprising:
a piston carried by the vehicle disc brake assembly, the piston having a bore provided with an inner cone surface and an internal groove formed in an inner wall of the bore;
an adjusting strut part disposed within the bore of the piston, the strut part having a flange provided thereon and configured to contact the inner cone surface; and
a single, one-piece clutch spring carried by the strut part within the bore of the piston;
wherein the clutch spring includes a main body having at least three legs extending therefrom, each of the legs including an outermost remote end configured to be received in the internal groove of the piston to thereby secure the clutch spring within the piston and each of the legs configured to provide a spring force which is operative to bias the flange of the strut part against the inner cone surface of the piston, and wherein each of the legs is axially and radially deflectable relative to the main body.

18. The vehicle disc brake assembly of claim 17 wherein each of the legs is bifurcated and includes a first leg portion, a second leg portion, a third leg portion, a fourth leg portion, and a fifth leg portion.

19. The vehicle disc brake assembly of claim 18 wherein the first leg portion is a generally curved transition leg portion and extend generally perpendicular to the main body, the second leg portion extends in a generally axially outwardly extending direction relative to the main body, the third leg portion is angled inwardly so as to extend in a generally radially inwardly extending direction relative to the second leg portion, the fourth leg portion is angled slightly inwardly so as to extend in a generally radially inwardly extending direction relative to the third leg portion, and fifth leg portion is curved in a radially outwardly extending direction relative to the fourth leg portion.

20. The vehicle disc brake assembly of claim 17 wherein each of the legs further includes a protuberance provided thereon which extends in a direction back toward the and past the main body.
